(19) United States
(12) Patent Application Publication
(10) Pub. No.: US 2025/0251557 A1
(43) Pub. Date: Aug. 7, 2025

(54) DETACHABLE OPTICAL FIBER-TO-WAVEGUIDE COUPLING

(71) Applicant: Applied Materials, Inc., Santa Clara, CA (US)

(72) Inventors: Zijiao Yang, Fremont, CA (US); Jinxin Fu, Santa Clara, CA (US); Hans-Juergen Schmidtke, Mountain View, CA (US); Ludovic Godet, Sunnyvale, CA (US)

(21) Appl. No.: 19/046,469

(22) Filed: Feb. 5, 2025

Related U.S. Application Data
(60) Provisional application No. 63/704,096, filed on Oct. 7, 2024.
(60) Provisional application No. 63/550,754, filed on Feb. 7, 2024.

(51) Int. Cl. G02B 6/42

(52) U.S. Cl. CPC G02B 6/4292; G02B 6/4214

(57) ABSTRACT

Embodiments described herein are related to enabling detachable optical fiber-to-waveguide coupling. A system can include a first connection component including a waveguide and a mirror formed on a base structure, the base structure including at least one photonic integrated circuit (PIC) formed on a substrate, and a detachable second connection component coupled to an optical fiber. The detachable second connection component is configured to mate with the first connection component to enable optical signal coupling between the optical fiber and the waveguide. The mirror is configured to at least one of: reflect a first optical signal received from the waveguide to the optical fiber, or reflect a second optical signal received from the optical fiber to the waveguide.

### CROSS-REFERENCE TO RELATED APPLICATION(S)

The present application claims priority to U.S. Provisional Patent Application No. 63/550,754, filed on Feb. 7, 2024 and entitled “DETACHABLE OPTICAL FIBER-TO-WAVEGUIDE COUPLING”, and U.S. Provisional Patent Application No. 63/704,096, filed on Oct. 7, 2024 and entitled “DETACHABLE OPTICAL FIBER-TO-WAVEGUIDE COUPLING”, the entire contents of each of which are hereby incorporated by reference herein.

### TECHNICAL FIELD

Embodiments of the present disclosure relate to optical systems, and more particularly to enabling detachable optical fiber-to-waveguide coupling.

### BACKGROUND

In an optical system, an optical signal can travel through a waveguide (e.g., optical fiber) that is formed from an inner core made of a first material having a first index of refraction and an outer cladding made of a second material having a second index of refraction less than the first index of refraction. For example, the first material and the second material can each be formed from a different type of glass. Thus, when an optical signal traveling in a waveguide is incident on the boundary between the inner core and the outer cladding at an angle exceeding the critical angle, the optical signal can exhibit total internal reflection. At the boundary, an evanescent wave can be generated from the optical signal. Generally, an evanescent wave is an oscillating wave (e.g., electromagnetic wave or acoustic wave) generated at a boundary between two media and exists only within a very short distance from the boundary. Evanescent waves can exit the waveguide, and their amplitude can decay exponentially as a function of distance from the boundary. Thus, evanescent waves are generally observable in the near field of the optical signal in close proximity to the boundary.

Evanescent wave coupling generally refers to a (quantum) tunneling phenomenon in which an evanescent wave exiting a first medium excites a wave in an adjacent medium that is sufficiently close to the first medium. For example, in an optical communication system, evanescent wave coupling can occur when an evanescent wave generated within a waveguide excites an electromagnetic wave in an adjacent waveguide. Evanescent wave coupling can be accomplished when two waveguides are positioned close together such that the evanescent field generated by one of the waveguides reaches the other waveguide before any substantial decay of the evanescent wave is experienced.

### SUMMARY

In some embodiments, a system includes a first connection component including a waveguide and a turning element formed on a base structure, the base structure including at least one photonic integrated circuit (PIC) formed on a substrate, and a detachable second connection component coupled to an optical fiber. The detachable second connection component is configured to mate with the first connection component to enable optical signal coupling between the optical fiber and the waveguide. The turning element is configured to at least one of: reflect a first optical signal received from the waveguide to the optical fiber, or reflect a second optical signal received from the optical fiber to the waveguide.

In some embodiments, a method includes receiving a base structure including at least one photonic integrated circuit (PIC) formed on a substrate, forming, on the base structure, a first connection component comprising a waveguide and a turning element, and mating the first connection component to a detachable second connection component coupled to an optical fiber to enable optical signal coupling between the optical fiber and the waveguide. The turning element is configured to at least one of: reflect a first optical signal received from the waveguide to the optical fiber, or reflect a second optical signal received from the optical fiber to the waveguide.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a diagram of a perspective view of at least a portion of a co-packaged substrate having one or more electrical and photonic devices formed thereon, in accordance some embodiments.

FIGS. 2A-2B are diagrams of top views of photonic integrated interconnect units, according to some embodiments.

FIGS. 3-5 are diagrams of cross-sectional views of portions of a photonic integrated interconnect unit, according to some embodiments.

FIG. 6 is a diagram of a cross-sectional view of a portion of a pluggable connector, according to some embodiments.

FIGS. 7A-13C are diagrams of views of example devices implementing detachable optical fiber-to-waveguide coupling, according to some embodiments.

FIG. 14 is a flowchart of an example method to fabricate a system to enable detachable optical fiber-to-waveguide coupling, according to some embodiments.

### DETAILED DESCRIPTION

Embodiments of the present disclosure relate to enabling detachable optical fiber-to-waveguide coupling. A co-packaged device (e.g., multi-chip module) can include a package substrate having multiple integrated circuit devices assembled closely together. More specifically, optical components can be integrated on substrates (e.g., silicon (Si) substrate) for fabricating large-scale photonics integrated circuits that co-exist with micro-electronic chips. With the use of an optical transceiver, received optical signal can be converted to an electrical signal capable of being processed by an integrated circuit, or the processed electrical signal can be converted to an optical signal to be transmitted via an optical fiber.

A co-packaged device can include an interconnect device (“interconnect”) formed between a first component and a second component. For example, an interconnect can be a placed between a package substrate and a ball grid array. In some embodiments, an interconnect includes an interposer. An interposer is an electrical interface that routes connections between sockets or connections between the first component and the second component. An interposer can be used to connect components that may not naturally connect to one another.

Coupling of optical fibers to waveguides on a photonic integrated circuit (PIC) can be implemented using an optical fiber connector (“connector). A connector can be a single-fiber (or simplex-fiber) connector, a duplex-fiber connector, or a multi-fiber connector. Examples of types of standard connectors include SC (square connector) connectors, FC (ferrule connector) connectors, little or local LC (little connector or local connector) connectors, ST (straight tip) connectors, and MPO (multi-fiber push-on) connectors. One example of an MTO connector is an MTP® (multi-fiber termination push-on) connector.

A connector can include a connection substrate having multiple grooves formed therein, into which multiple respective optical fibers can be inserted and secured. Each optical fiber can be coupled to a respective waveguide. A connection substrate can be formed with a geometry that can provide the proper spacing to achieve optical coupling (e.g., evanescent wave coupling). For example, a large number of optical fiber-to-waveguide couplings may be needed for a multi-channel wavelength division multiplexing (WDM) optical system.

One type of a connection substrate is a V-groove connection substrate, which is a substrate having multiple V-grooves formed therein. A V-groove is an opening that has a tapered shape in which the sides of the groove converged to a point (e.g., triangular shape). For each V-groove, an optical fiber can be inserted into the V-groove and secured in the V-groove using an adhesive (e.g., glue).

Typically, standard types of connectors in which an optical fiber is secured into a connection substrate do not support detachability of optical fibers from PICs. This limits the flexibility of optical fiber-to-waveguide coupling and makes it more difficult to repair a broken optical fiber secured within the connection substrate. Some non-standard (e.g., customized) connectors can be designed to enable detachability of the connectors from PICs. However, designing, fabricating and/or utilizing such non-standard connectors can, in comparison to standard connectors, add additional complexity and/or cost.

Some surface optical signal coupling solutions can use a grating coupler, formed in a cladding layer formed on a substrate, to direct an incoming optical signal into a waveguide formed by an inner core formed within the cladding layer. However, such coupling solutions can contribute to high loss (e.g., greater than or equal to about 2 decibels (dB)) and small 1-dB bandwidth in wavelength (e.g., less than or equal to about 30 nanometers (nm)). Alternatively, some surface coupling solutions can use a turning element, such as a mirror, formed in a cavity or trench formed within the cladding layer and the substrate, to direct an incoming optical signal into the waveguide formed by an inner core formed within the cladding layer. However, such coupling solutions may require turning element (e.g., mirror) alignment and bonding, which may not meet alignment tolerances for edge coupling (e.g., 1 dB alignment tolerance is typically less than or equal to about 2 micrometers (μm)).

Aspects and implementations described herein can address these and other drawbacks by enabling detachable optical fiber-to-waveguide coupling with standard optical fiber connector types. A co-packaged device described herein can include a substrate and at least one PIC formed on the substrate and in electrical communication with the substrate. For example, a ball grid array (e.g., array of solder balls) can be formed between the substrate and the PIC.

A connector system can include a first connection component integrated within the co-packaged device. In some embodiments, the first connection component is attached to the at least one PIC. In some embodiments, the first connection component is attached to the substrate.

The connector system can further include a second connection component coupled to an optical fiber. The first connection component and the second connection component can each be designed to have a geometry to enable the second connection component to be received by the first connection component.

In some embodiments, the first connection component is a female connection component having a set of openings, and the second connection component is a male connection component having a set of protrusions. In alternative embodiments, the first connection component is component is a male connection component having a set of protrusions, and the second connection component is a female connection component having a set of openings. Each opening is designed to receive a respective protrusion of the set of protrusions.

In some embodiments, the connector system enables optical fiber-to-waveguide coupling on a plane parallel to an upper surface of the substrate (e.g., horizontal coupling). For example, the first connection component can be attached to the PIC or the substrate in a manner enables the second connection component to be received along the plane parallel to the upper surface of the substrate.

In some embodiments, the connector system enables optical fiber-to-waveguide coupling on a plane perpendicular to (e.g., orthogonal to) the upper surface of the substrate (e.g., vertical coupling). For example, the first connection component can be attached to the PIC or the substrate in a manner enables the second connection component to be received along the plane perpendicular to the upper surface of the substrate.

Various types of connector systems enabling detachable optical fiber-to-waveguide coupling with detachable optical fiber connectors can be implemented in accordance with embodiments described herein.

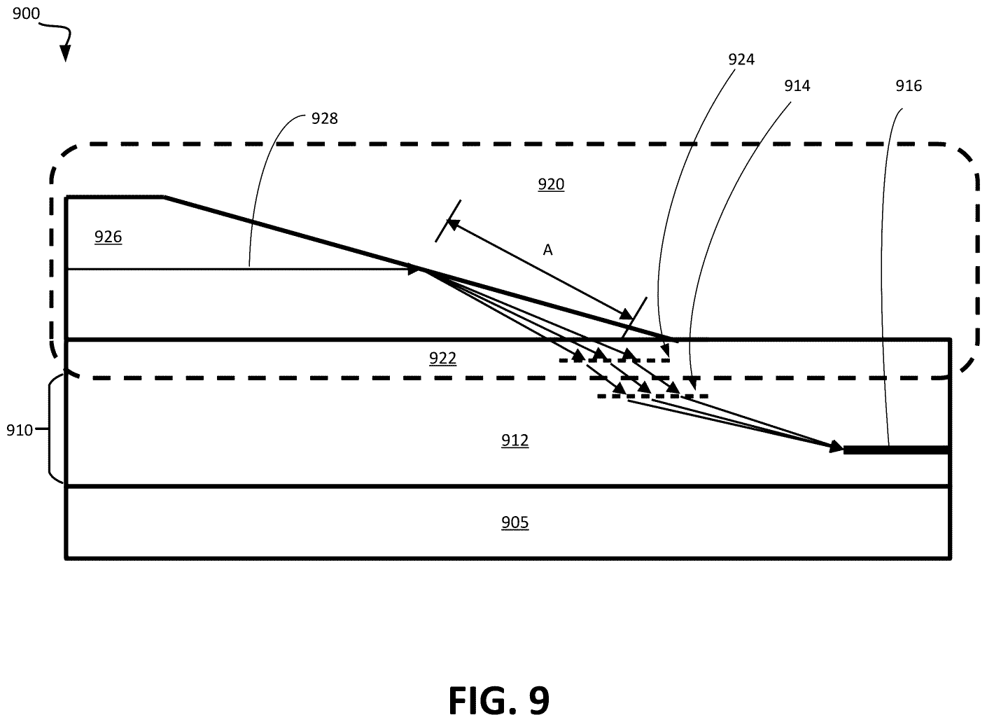

In some embodiments, a connector system enabling detachable optical fiber-to-waveguide coupling with detachable optical fiber connectors is a cleaved optical fiber connector system. For example, the cleaved optical fiber connector system can be an angle-cleaved optical fiber connection system. In an angle-cleaved optical fiber connection system, the first connection component can include a cladding layer and the second connection component can include an angle-cleaved optical fiber. A first portion of a collimator assembly and a waveguide can be formed within the cladding layer, and the second connection component can include an angle-cleaved optical fiber and a second portion of the collimator assembly. A collimator assembly can include a set of lenses that can be used to collimate optical signals. In some embodiments, the collimator assembly is a meta-lens assembly. In some embodiments, the collimator assembly is a microlens assembly. The angle-cleaved optical fiber is designed with a geometry and a cladding layer having a suitable index of refraction such that an optical signal can, upon incidence at a boundary between the angle-cleaved optical fiber and the atmosphere, be directed toward the collimator assembly via total internal reflection. The collimator assembly can be designed such that the optical signal is received by an end of the waveguide within the first connection component. Accordingly, an angle-cleaved optical fiber connector system can enable off-axis coupling. An example of an angle-cleaved optical fiber connector system will be described below with reference to FIG. 9.

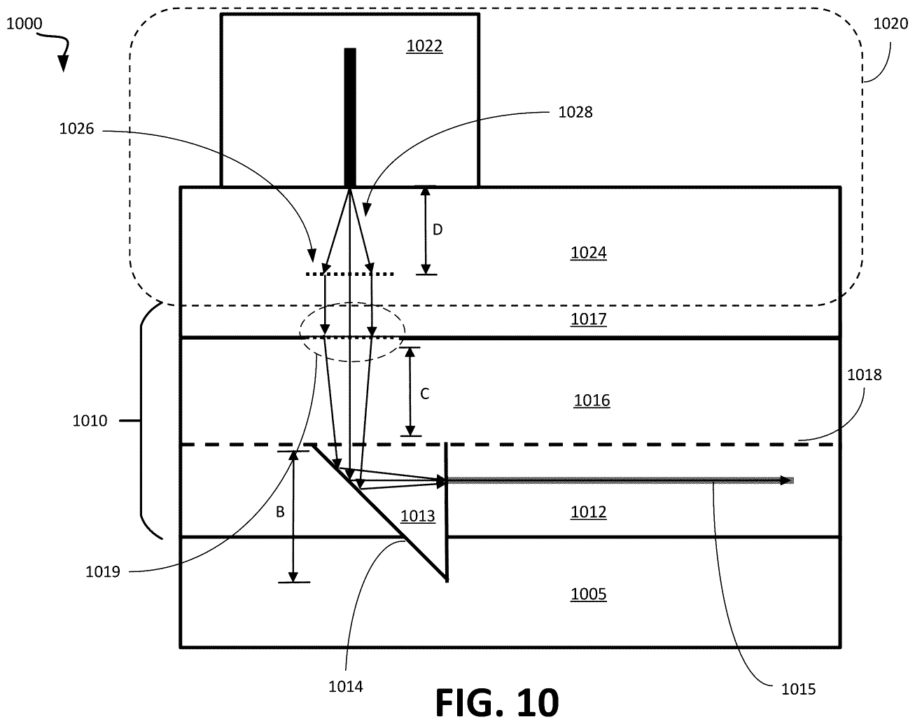

As another example, a cleaved optical fiber system can include a first connection component, and a second connection component including a cleaved optical fiber. The first connection component can include a first cladding layer formed on a first substrate and bonded to a second substrate, and a first portion of a second cladding layer formed on the second substrate. A turning element (e.g., mirror) and a waveguide can be formed within the first cladding layer. More specifically, a trench can be formed through at least the first cladding layer, and the turning element can be an angled mirror coated on a sidewall of the trench designed to reflect the optical signals toward the waveguide. A first portion of a collimator assembly can be formed about an interface between the second substrate and the first portion of the second cladding layer. The second connection component can further include a second portion of the second cladding layer formed underneath the cleaved optical fiber, and a second portion of the collimator assembly formed within the second portion of the second cladding layer. The collimator assembly can be designed such that optical signals are directed toward the turning element to enable the optical signals to be directed toward the waveguide. An example of this type of cleaved optical fiber connector system will be described below with reference to FIG. 10.

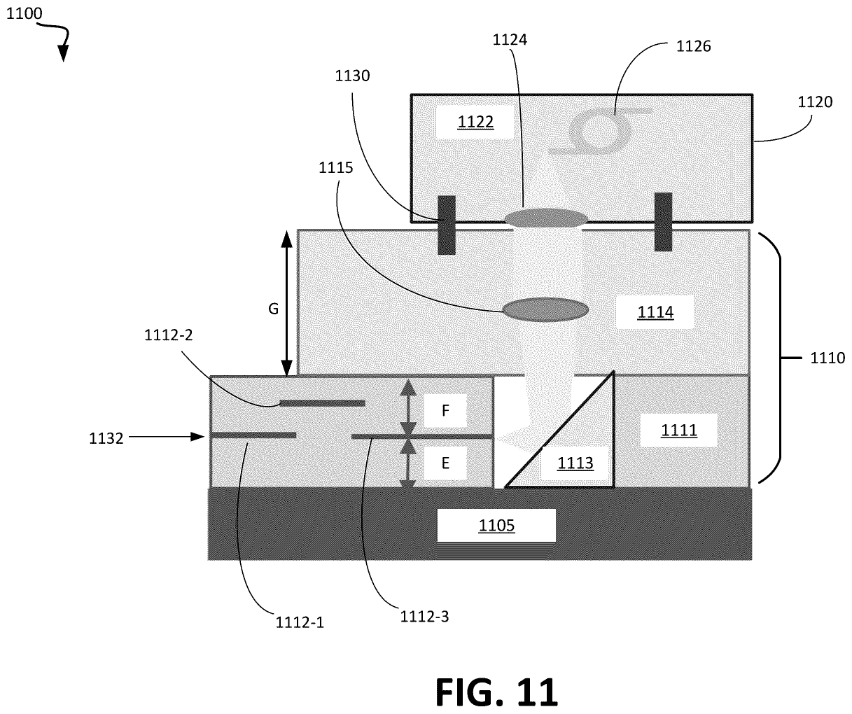

In some embodiments, a connector system enabling detachable optical fiber-to-waveguide coupling with detachable optical fiber connectors is a refractive collimation optics connector system. For example, the first connection component can include a first layer and a second layer formed on the first layer. The first layer can be a cladding layer and a set of waveguides and a turning element (e.g., mirror) can be formed within the first layer. More specifically, the turning element can be formed within a cavity formed within the first layer. A first portion of a collimator assembly can be formed within the second layer, and the second connection component can include a second portion of the collimator assembly and an output optical fiber. In some embodiments, the collimator assembly is a meta-lens assembly. In some embodiments, the collimator assembly is a microlens assembly. An example of a connector system including a detachable optical fiber connector formed from a cleaved optical fiber, a collimator assembly, and an etched mirror to couple optical signals to a waveguide will be described below with reference to FIG. 11.

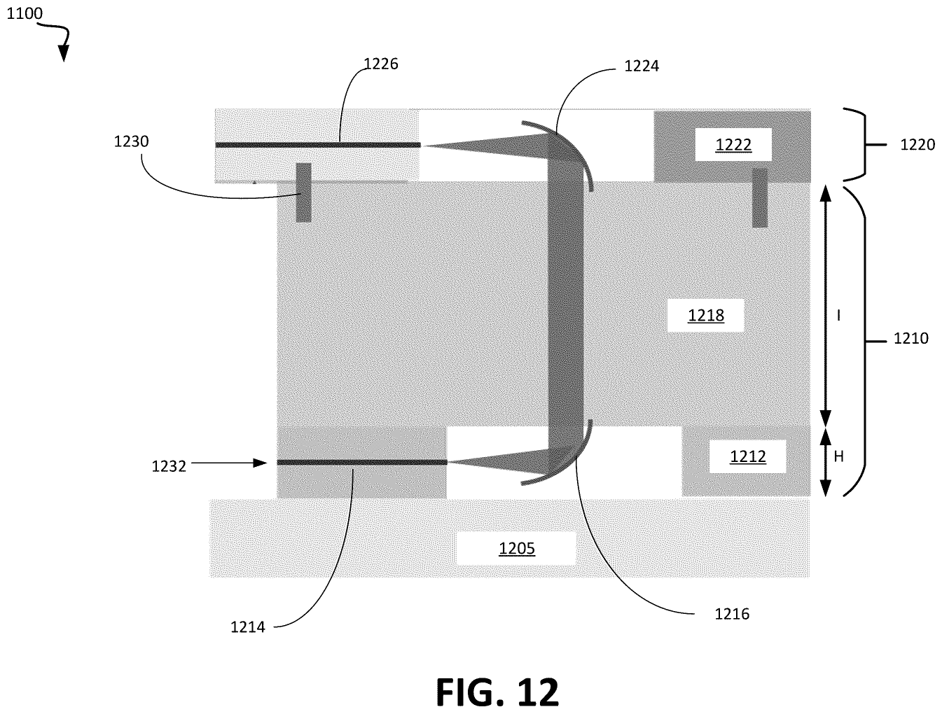

In some embodiments, a connector system is a reflective collimation optics connector system. For example, the first connection component can include a cladding layer. A waveguide and a first portion of a collimator assembly can be formed within the cladding layer, and the second connection component can include a second portion of the collimator assembly and an output optical fiber. In some embodiments, the collimator assembly is a meta-lens assembly. In some embodiments, the collimator assembly is a microlens assembly. In some embodiments, the first connection component further includes a spacer layer formed on the cladding layer to provide additional separation between the first portion of the collimator assembly and the second portion of the collimator assembly. An example of a connector system including a detachable optical fiber connector formed from a cleaved optical fiber, a collimator assembly, and an etched mirror to couple optical signals to a waveguide will be described below with reference to FIG. 12.

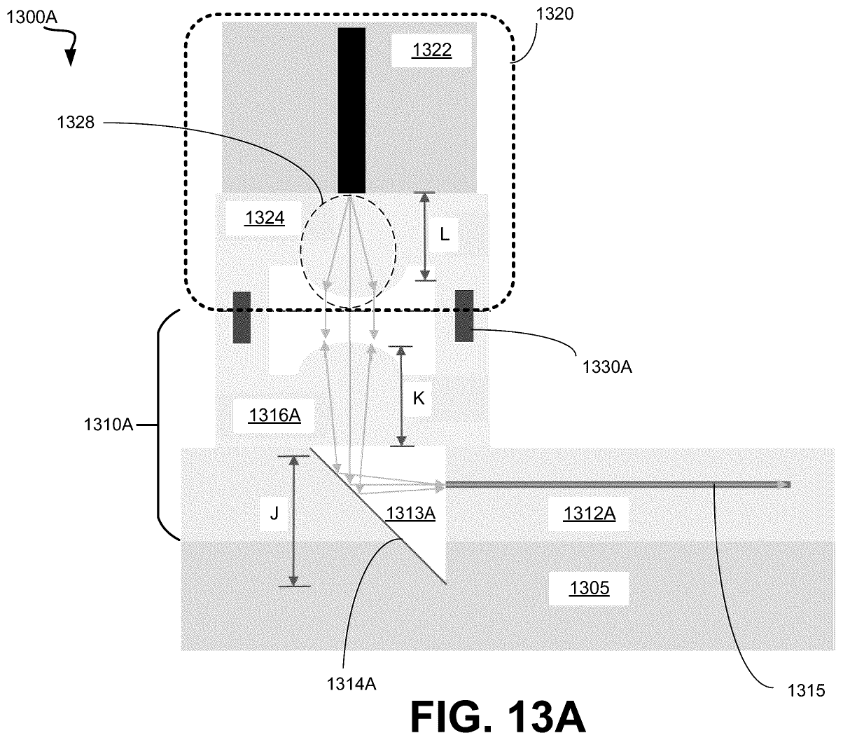

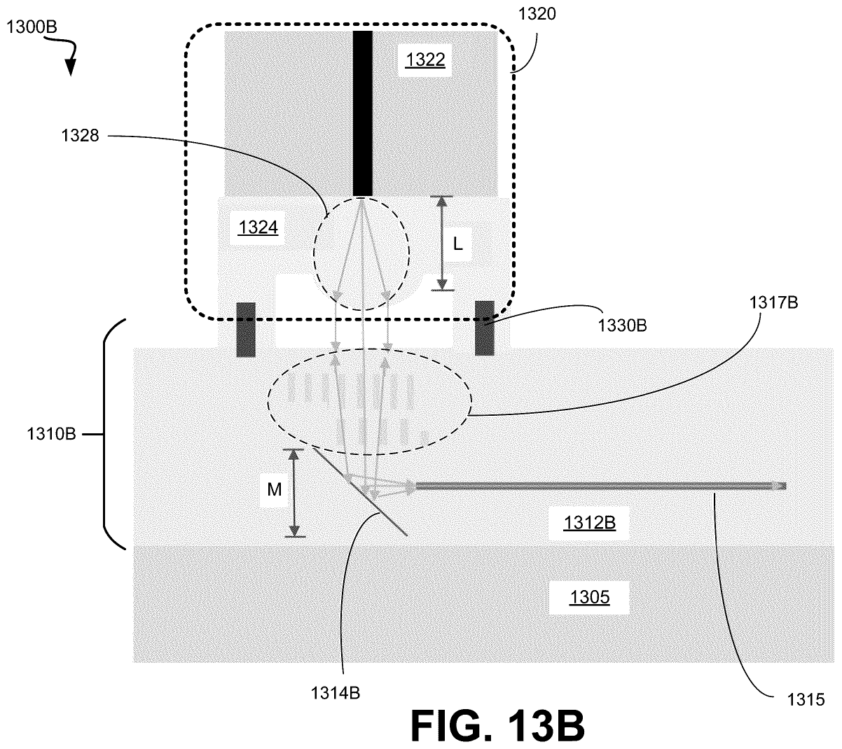

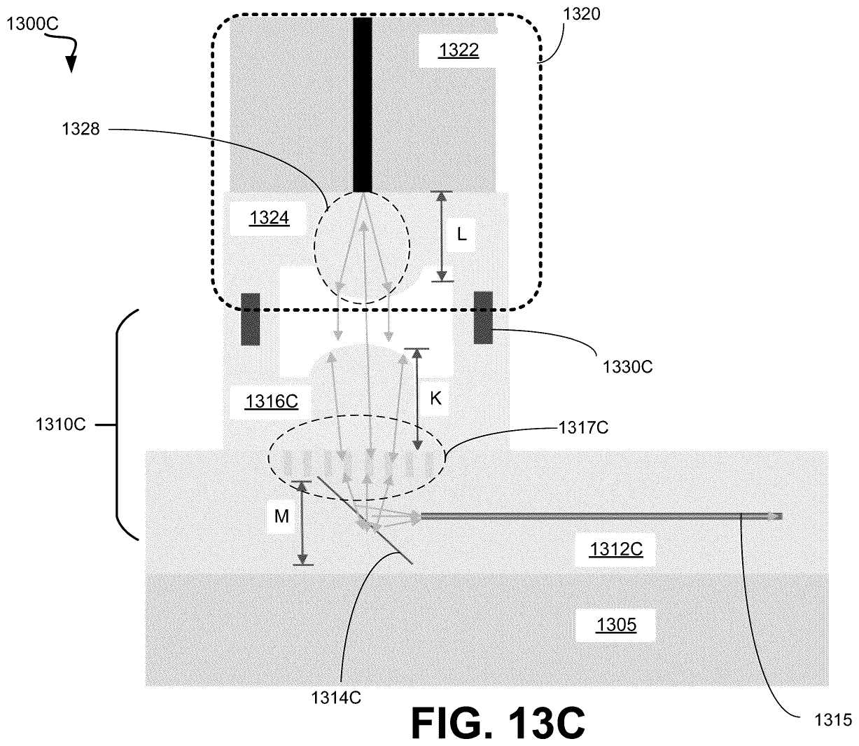

As another example, a cleaved optical fiber system can include a first connection component, and a second connection component attached to the first connection component. The first connection component can include a cladding layer formed on a substrate. A turning element (e.g., mirror) and a waveguide can be formed within the cladding layer. More specifically, a trench can be formed through at least the cladding layer, and the turning element can be an angled mirror coated on a sidewall of the trench designed to reflect the optical signals toward the waveguide. The second connection component can include a cleaved optical fiber. The first connection component includes a first portion of a collimator assembly formed on the cladding layer, and the second connection component includes a second portion of the collimator assembly formed underneath the cleaved optical fiber. The collimator assembly can be designed such that optical signals are directed toward the turning element to enable the optical signals to be directed toward the waveguide. In some embodiments, the first portion of the collimator assembly includes a first microlens, and the second portion of the collimator assembly includes a second microlens. An example of this type of cleaved optical fiber connector system will be described below with reference to FIG. 13A. In some embodiments, the first portion of the collimator assembly includes a metalens array formed within the cladding layer, and the second portion of the collimator assembly includes a microlens. An example of this type of cleaved optical fiber connector system will be described below with reference to FIG. 13B. In some embodiments, the first portion of the collimator assembly includes a first microlens, and a metalens array formed within the cladding layer, and the second portion of the collimator assembly includes a second microlens. An example of this type of cleaved optical fiber connector system will be described below with reference to FIG. 13C.

A turning mirror described herein can reflect light up with accurate angle and position control, so that the collimator assembly (e.g., microlens and/or metalens array) can expand and collimate the light emitted from the waveguide into a large light beam (e.g., 30-150 um diameter). On the fiber connector side, the size of the light beam can be expanded from 10 um at the fiber core to 30-150 um after the microlens. Matching two large beam modes (30-150 um diameter) with low loss can become possible, as detachable mechanisms described herein can enable a 1 um-5 um alignment accuracy, which is tolerable for 30-150 um light beam sizes.

Embodiments described herein can provide for numerous other technical advantages. For example, embodiments described herein can enable detachable optical fiber-to-waveguide coupling with standard connector types, instead of non-standard connector types, which can reduce device complexity. As another example, embodiments described herein can be used to enable detachable optical fiber-to-waveguide coupling with detachable optical fiber connectors formed from a cleaved optical fiber and meta-lens array, which can reduce device complexity (e.g., no grating coupler or drop-in mirror needed for coupling optical signals to a waveguide through a surface), reduce loss, increase bandwidth in wavelength and improve alignment accuracy.

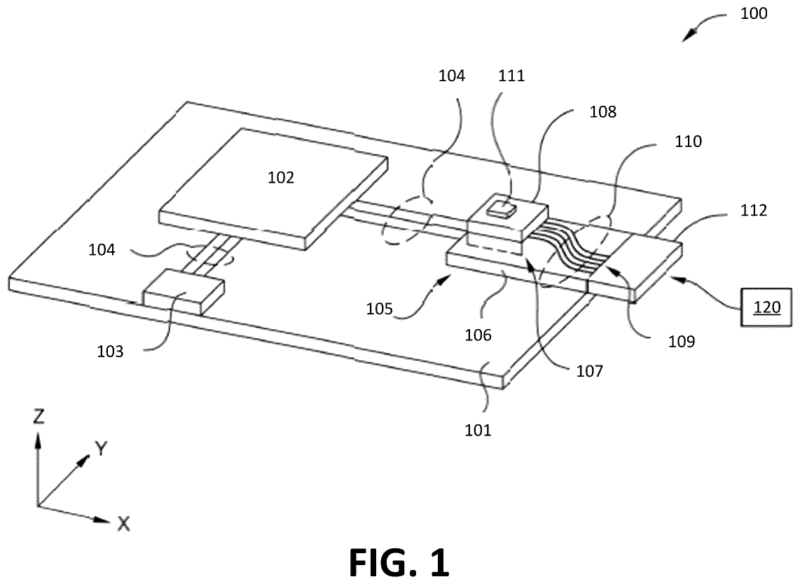

FIG. 1 is a diagram of a perspective view of a system including a co-packaged device 100, in accordance some embodiments. The co-packaged device 100 can include an electrical or opto-electrical chip (“chip”) 102 connected by a waveguides or electrical trace interconnect 104 to a photonic integrated interconnect unit 103 where all are formed on or formed on a package substrate 101. In some embodiments, the chip 102 includes any high-density chip having a high input/output (I/O) pin count. In one example, the high-density chip has between 100 and 2000 I/O pins or up to and greater than 2000 I/O pin counts. For example, the chip 102 can be a data center SWITCH chips, an artificial intelligence (AI) chip, etc.

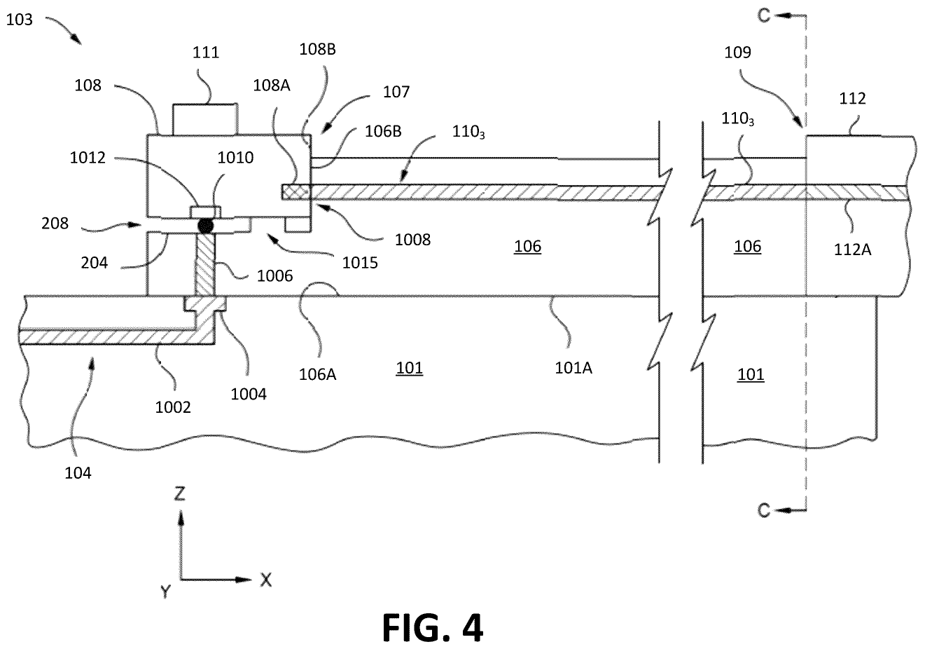

The photonic integrated interconnect unit 103 includes a fiber connector region configured to be coupled to a fiber connector 112 for removably connecting a fiber cable 120 to the photonic integrated interconnect unit 103. In some embodiments, the fiber cable 120 is plugged into the fiber connector 112 to operably connect the fiber cable 120 to the co-packaged device 100. In an embodiment, the photonic integrated interconnect unit 103 is configured for connecting fiber cables 120 including, but not limited to, single-mode fiber optic cables having 9 um fiber core diameters. The fiber connector 112 may further include optical fibers 112A (FIG. 4) to operably connect fiber cables 120 having between 1 to 74 fiber cores, 74 to 148 fiber cores, and up to and greater than 148 fiber cores to the photonic integrated interconnect unit 103.

In some embodiments, the photonic integrated interconnect unit 103 is configured to transmit signals between the chip 102 and the fiber cable 120 connected to the photonic integrated interconnect unit 103. The photonic integrated interconnect unit 103 includes a photonic glass layer (PGL) substrate 106, optical structures 110₁-110_{N} formed integral with or on the PGL substrate 106, an optical transceiver integrated circuit (chip) 108 mounted on the PGL substrate 106 and coupled to the optical structures 110₁-110_{N} at a first interface 107, and the fiber connector 112 connected to both the PGL substrate 106 and the optical structures 110₁-110_{N} at a second interface 109.

The chip 108 operates to convert electrical signals to optical signals, and vice versa. In some embodiments, the chip 108 is a silicon photonic (SiPho) chip. The optical structures 110₁-110_{N} operate to transmit optical signals between the chip 108 and the fiber connector 112, and the optical waveguide or electrical trace interconnect 104 operate to transmit electrical or optical signals between the photonic integrated interconnect unit 103 (e.g., the chip 108) and the chip 102. The optical waveguide or electrical trace interconnect 104 can include metal traces that are formed within the package substrate 101, which in some embodiments can include metal traces formed in a printed circuit board (PCB) substrate or metal traces formed within multiple redistribution layers (e.g., dielectric containing layers) formed over a solid core substrate (e.g., silicon or glass core substrate).

A photonic engine 105 may optionally further include one or more electronic phy chips 111 that are coupled to the chip 108. The electronic phy chip 111 is generally used to assist with operations performed by an optical chip. In some embodiments, the electronic phy chip 111 is operably connected to the chip 108 to assist the chip 108 with various electrical functions. As shown, the electronic phy chips 111 may be mounted on top of the chip 108 and thereby directly connected to the chip 108. Alternatively, the electronic phy chip 111 may be embedded in the PGL substrate 106 and connected to the chip 108 through the PGL substrate 106, which is often simply referred to herein as a substrate 106. Further, the electronic phy chip 111 can be mounted on or embedded in the package substrate 101 and connected to the chip 108 through electrical interconnect 104.

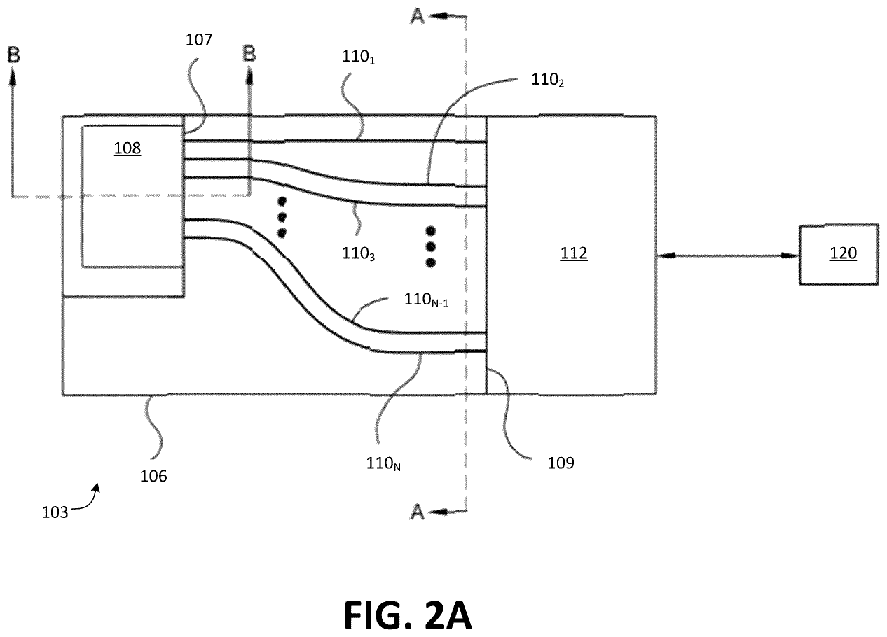

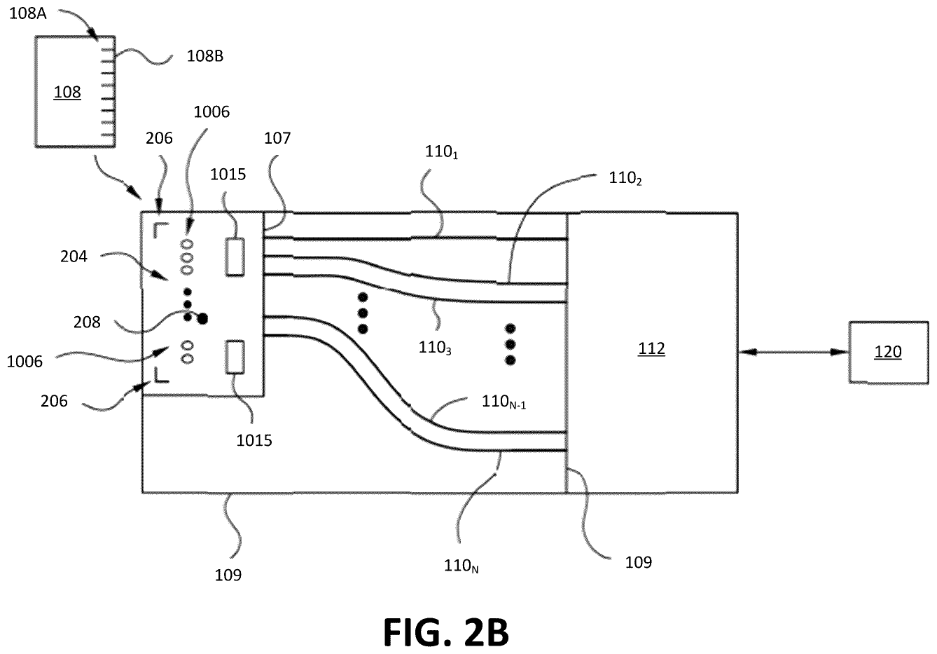

FIGS. 2A-2B are diagrams of top views of the photonic engine 105, according to some embodiments. As shown in FIG. 2A, the photonic engine 103 includes the chip 108 mounted near one end of the PGL substrate 106, the fiber connector 112 connected at an opposite end of the PGL substrate 106 from the chip 108, and the optical structures 110₁-110_{N} extending between the chip 108 and the fiber connector 112. In some embodiments, each of the optical structures 110₁-110_{N} include a light transmitting region for transmitting light in either direction between the first interface 107 and the second interface 109. The light being transmitted through the optical structures can be either received from one or more waveguides 108A (FIG. 2B) of the chip 108 or received from one or more optical fibers within the fiber connector 112 that a light signal source is in communication with during use. The chip 108 is typically configured to receive light (e.g., detect) transmitted through the optical structures 110₁-110_{N} and also emit light (e.g., transmit) into the optical structures 110₁-110_{N} in an effort to communicate with external devices connected through the fiber connector 112. The chip 108 can be configured to transmit light into the optical structures 110₁-110_{N} by at least the use of light emitters integrated into chip 108, or by use of light emitters that are external to PGL substrate 106. In the case where the light emitters are external to PGL substrate 106 the light is delivered to chip 108 via the optical structures 110₁-110_{N} and then modulated by the chip 108 to create a transmit signal that is provided to the optical structures 110₁-110_{N}. In some embodiments, which can be combined with other embodiments described herein, the optical structures 110₁-110_{N} are formed on (e.g. directly or indirectly) or are integral with the PGL substrate 106.

In some embodiments, which can be combined with other embodiments described herein, the light transmitting region within each of the optical structures 110₁-110_{N} may have the same cross-sectional dimensions, such as height and width. In another embodiment, which can be combined with other embodiments described herein, the light transmitting region within at least one of the optical structures 110₁-110_{N} may have at least one different cross-sectional dimensions, such as one of height and width, from the dimensions of the other optical structures 110 within the PGL substrate 106. In one embodiment, which can be combined with other embodiments described herein, the light transmitting region within each of the optical structures 110₁-110_{N} may have the same refractive index. In another embodiment, which can be combined with other embodiments described herein, the light transmitting region within at least one of the optical structures 110₁-110_{N} may have a different refractive index or multiple different refractive indexes or a gradual gradation of refractive indexes or other index varying structures when compared with the rest of the optical structures 110₁-110_{N} within the PGL substrate 106.

In some embodiments, the number of optical structures 110₁-110_{N} formed in the PGL substrate 106 is dependent on the number of waveguides 108A in the chip 108 needing to be connected, which may also correspond with the number of fiber connections to be connected to the chip 102. In some embodiments, the chip 102 may comprise seventy-two (72) fiber connections such that seventy-two (72) corresponding interconnects 104 extend from the chip 102 and connect to seventy-two (72) corresponding fibers and waveguides 108A in the chip 108 of the photonic engine 105. To appropriately connect the chip 108 to the fiber connector 112 via the optical structures 110₁-110_{N} in the photonic glass layer substrate 106, seventy-two (72) corresponding optical structures 110 are formed on or integral with the PGL substrate 106. In this example, as shown in FIGS. 2A-2B, N equals 72, and thus the optical structures 110 are spaced apart in the X-Y plane from one edge of the PGL substrate 106 to the other edge of the PGL substrate 106. In this example, optical structure 110₁ is positioned near the top-most edge and optical structure 110₇₂ would be positioned closest to the bottom most edge of FIG. 2A. As discussed further below, the optical structures 110₁-110_{N} are spaced apart and separated by a material that has different optical properties, such as index of refraction (n), than the light transmitting portions of the optical structures 110₁-110_{N}.

The optical structures 110₁-110_{N} are generally sized and configured to appropriately connect to the waveguides 108A within the chip 108. In an embodiment, the waveguides 108A (FIG. 2B) at the output of the chip 108, or portion that is to communicate with the optical structures, have a core with a height dimension that is about 1 um in cross-sectional size. In one configuration, the output of the chip 108 has a square or rectangular shaped cross-section that has at least one dimension that is equal to about 1 μm in length. For example, a square cross-section of a waveguide 108A may have a core that is 1 μm height and width. Light transmitted to and from the chip 108 would thus be transferred through the 1 μm waveguides 108A.

In contrast, light transmitted to and from the fiber cable 120 through the fiber connector 112 can have a different form factor, such as having a core cross sectional dimension of about 9 μm in size. For example, the fiber connector 112 may have a square, rectangular or circular cross-section with a core having a height dimension that is about 9 μm in size. As such, in some embodiments, each of the optical structures 110₁-110_{N} is formed such that light propagating through the optical structures 110₁-110_{N} between the chip 108 and the fiber cable 120 is expanded or compressed accordingly depending on the direction of propagation of the optical signal. In one example, the optical structures 110₁-110_{N} extending from the second interface 109 adjacent to the 9 μm fibers in the fiber connector 112 have transmission regions with cross-sectional areas that vary at different portions of the respective structures to facilitate coupling to the 1 μm waveguides 108A in the chip 108. In one embodiment, the optical structures 110₁-110_{N} are tapered along at least a portion of their length from a 9 μm dimensional core size until they are near 1 μm dimensional core size near the first interface 107, where it is assumed that the varying dimensional core size relates to a dimension of a side of a square or rectangular cross-sectional shaped optical structure 110. In some embodiments, the tapered optical structures 110 have a cross-sectional area ratio, which if measured at one end versus measured at the opposing end of the optical structure 110 is greater that 1:1 and less than about 1:100, or less than 1:81. In some embodiments, the optical structures 110₁-110_{N} extending from the second interface 109 adjacent to the fiber connector 112 have a varying refractive index along at least a portion of their length from the second interface 109 to the first interface 107 to facilitate coupling between the optical elements within the chip 108 and the fiber connector 112 that have different cross-sectional dimensions.

In another aspect, the photonic engine 105 is configured such that the transmission loss of the optical signal between the first interface 107 and the second interface 109 is approximately or less than 3 dB, inclusive of loss due to the transmission of the optical signal through the optical structures 110₁-110_{N} themselves. In some embodiments, the transmission loss may largely be dependent on the coupling at the first interface 107 between the chip 108 and the optical structures 110₁-110_{N}. As shown in FIG. 2B, in an embodiment, the chip 108 is to be mounted on a coupling surface 208 at a chip mounting region 204 of the PGL substrate 106. When mounted on chip mounting region 204, the waveguides 108A formed on the side surface 108B of the chip 108 are aligned with the optical structures 110₁-110_{N} found at the first interface 107.

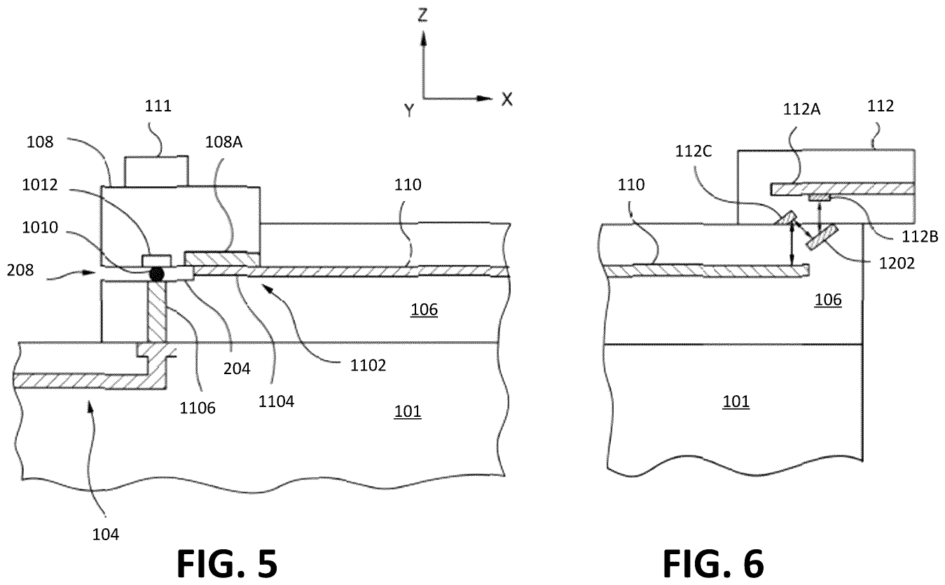

In some embodiments, the PGL substrate 106 further includes one or more fiducial marks 206 to assist in the alignment and mounting of the chip 108 on the chip mounting region 204. The one or more fiducial marks 206 operate to guide and help align the position of the chip 108 along the X-Y plane of the PGL substrate 106 to ensure mounting of the chip 108 occurs with proper alignment to one or more electrical contacts (e.g., vias 1006) and optical structure portions of the PGL substrate 106. As such, in an embodiment, the tolerance for error in the coupling or hybrid bonding the chip 108 and the optical structures 110₁-110_{N} together at the first interface 107, which will be discussed further below, may be in a range from 0.1 to 2 μm to ensure the connections are optimized for the lowest signal loss. In one embodiment, the misalignment of the centers of the waveguides 108A and the optical structures 110₁-110_{N} is maintained such that the lateral misalignment in the Y-direction (i.e., top to bottom direction in FIG. 2B) is less than 1 to 2 μm. In some embodiments, the misalignment of the centers of the waveguides 108A and the optical structures 110₁-110_{N} is also maintained such that the vertical misalignment in the Z-direction (FIGS. 4-5) is less than 1 to 2 μm. In one embodiment, the variability in the vertical misalignment can be dependent on the variability of the compression of solder balls 1011 or other electrical contact that is used to electrically couple the chip 108 to vias 1006 (shown in FIGS. 4-5) formed in a portion of the PGL substrate 106.

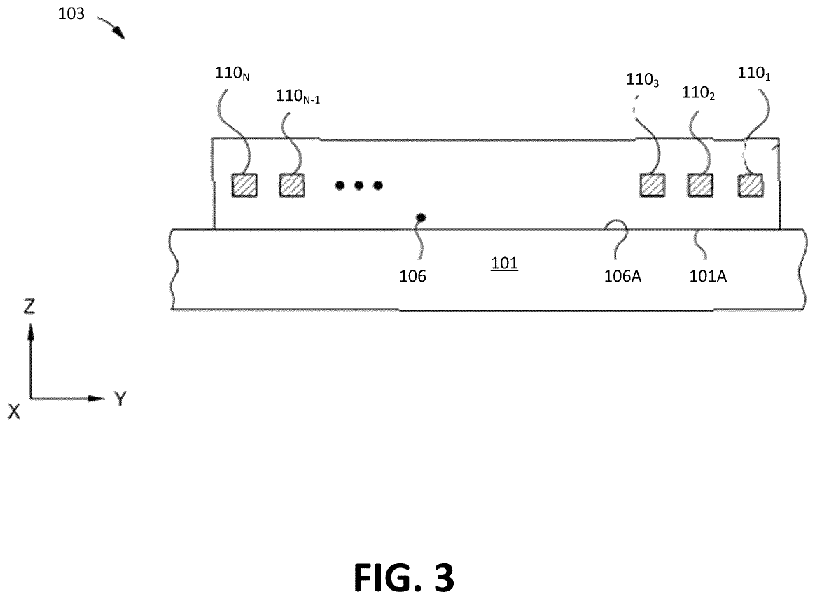

FIG. 3 is a diagram of a schematic, cross-sectional end view of a portion of the photonic engine 105 mounted on the package substrate 101 formed by use of the sectioning line C-C in FIG. 4., according to some embodiments. As shown in FIG. 3, the photonic engine 105 includes a bottom surface 106A of the photonic glass layer substrate 106 formed on a top surface 101A of the package substrate 101, with the optical structures 110₁-110_{N} extending through the PGL substrate 106. As shown, the optical structures 110₁-110_{N} extending through the PGL substrate 106 are each aligned in the X-Z plane of the PGL substrate 106. While FIG. 3 shows the optical structures 110₁-110_{N} formed in a single row in plane across the PGL substrate 106, other arrangements of the optical structures 110₁-110_{N} may be formed in the PGL substrate 106. For example, more than a single row of optical structures may be formed and stacked vertically. The arrangements of the optical structures 110₁-110_{N} is not intended to limit the scope of the disclosure provided herein.

FIG. 4 is a schematic, transverse cross-sectional lateral view of a portion of the photonic engine 105 mounted on the package substrate 101 that is formed by use of the sectioning line B-B in FIG. 2A, according to some embodiments. As shown in FIG. 4, the package substrate 101 includes circuit traces 1002 extending from interconnect pads 1004 formed integral in the top surface 101A of package substrate 101. In some embodiments, the circuit traces 1002 form the interconnects 104 that electrically connect the photonic engine 105 in contact with the interconnect pads 1004 to the chip 102. Alternatively, the circuit traces 1002 may electrically connect the photonic engine 105 in contact with the interconnect pads 1004 to other integrated circuits formed on the package substrate 101.

In some embodiments, the vias 1006 extend through a portion of the PGL substrate 106 between the coupling surface 208 and the bottom surface 106A of the PGL substrate 106. When the photonic engine 105 is mounted to the package substrate 101, the vias 1006 can be aligned with and placed in electrical contact with the corresponding interconnect pads 1004 that are exposed on the top surface 101A of package substrate 101 and are in electrical connection with the photonic integrated interconnect unit 103 through the circuit traces 1002 formed in the package substrate 101. In some embodiments, the vias 1006 alternatively connect the photonic engine 105 to one or more other integrated circuits (chips) embedded in the package substrate 101 or on the package substrate 101.

As shown in FIG. 4, the chip 108 can be actively or passively mounted on the coupling surface 208 of the PGL substrate 106 with the side surface 108B of the chip 108 are “butt-coupled” to an end surface 106B of the PGL substrate 106 at the first interface 107. When the chip 108 is butt-coupled to the end surface 106B of the PGL substrate 106, the end of the waveguide 108A in the chip 108 is also butt-coupled to a corresponding end of the optical structure 110, such as optical structure 1103, formed in the PGL substrate 106 at a fourth coupling interface 1008. The coupling of the waveguides 108A to the optical structures 110 at the fourth interface 1008 can impact the loss of optical signals between the chip 108 and the PGL substrate 106. As such, to minimize coupling loss, the aforementioned one or more fiducial marks 206 (FIG. 2B) are used during mounting of the chip 108 to assist in alignment and the precise placement of the chip 108 to optimize the butt-coupling of the waveguides 108A and the optical structures 110₁-110_{N} at the fourth interface 1008 and minimize coupling loss.

To connect the chip 108 to the PGL substrate 106, chip 108 further includes solder connects 1012 that are in contact with the solder balls 1011, wherein the solder balls 1011 are positioned between the solder connects 1012 and an end of each of the vias 1006 on the coupling surface 208. The solder balls 1011 electrically connect the chip 108 to the vias 1006 formed in the photonic glass layer substrate 106. In some embodiments, the solder balls or other interconnect bumps, pillars or interconnect materials, including planar hybrid bonding techniques, 1010 are used to connect the solder connects 1012 to the vias 1006 extending through the PGL substrate 106 to the package substrate 101. In the embodiment shown, the solder balls 1011 and the vias 1006 connect the solder connects 1012 to the plurality of interconnect pads 1004 in the package substrate 101, thereby electrically connecting the chip 108 to the circuit traces 1002 in the package substrate 101 connected to the plurality of interconnect pads 1004.

In some embodiments, the coupling surface 208 of the PGL substrate 106 further includes a plurality of recesses (not shown) for cradling each of the solder balls 1011 used to connect the solder connects 1012 in the chip 108 and the vias 1006 in the PGL substrate 106. The recesses may be formed to allow for expansion of the solder balls 1011 when flattened such that the contacting surface of the solder balls 1011 may be substantially flush with the coupling surface 208. The flattening of the solder balls 1011 on the coupling surface 208 when contacting the solder connects 1012 in the chip 108 helps ensure uniformity in the mounting of the chip 108 on the PGL substrate 106 as well as increases contact reliability of the solder balls 1011.

FIG. 4 also includes a cross-sectional view of a portion of the fiber connector 112 that is coupled to a portion of the PGL substrate 106 at the interface 109, according to some embodiments. The fiber connector 112 can be removably connected to a portion of the photonic engine 105 to allow the transmission to and receipt of optical signals from the optical structures 110 by use of a “butt-coupled” connection configuration.

FIG. 5 is a schematic, cross-sectional lateral view of a portion of the photonic engine 105 mounted on the package substrate 101, according to some embodiments. As shown, the chip 108 may be passively mounted on the photonic glass layer substrate 106 in a second chip mounting region 1106 of the photonic glass layer substrate 106. The second chip mounting region 1106 of the PGL substrate 106 further includes a coupling portion 1102 of each of the optical structures 110₁-110_{N} extending along a coupling surface 1104 of the PGL substrate 106. When the chip 108 is mounted on the second chip mounting region 1106, a portion of the waveguides 108A in the chip 108 are evanescently coupled with a surface of the corresponding coupling portions 1102 of each of the optical structures 110₁-110_{N} in the PGL substrate 106. The evanescent wave coupling of the waveguides 108A to the optical structures 110 allow for optical signals to be transferred between the coupled waveguides.

In some embodiments, the evanescently coupling of the waveguides may be formed as a directional coupler wherein the evanescent modes of one waveguide overlap with the modes of a second waveguide. When the evanescent modes of the waveguides overlap, evanescent fields generated by the respective waveguides also overlap such that the evanescent field generated by one waveguide may excite a wave in the other waveguide. As such, in one aspect, the coupling strength between the waveguides 108A and the optical structures 110 may therefore be sensitive to the distance between the waveguides 108A and optical structures 110, and/or the length of the coupling portion 1102. The coupling portion 1102 and respective contacting portion of the waveguides 108A may therefore be sized and formed to optimize the coupling and minimize coupling loss.

The mounting of the chip 108 on the substrate 106 in the chip mounting region 1106 of the substrate 106 further includes connecting the solder connects 1012 in the chip 108 to the vias 1006 in the PGL substrate 106 using the solder balls 1011. The solder balls 1011 may be positioned on the coupling surface 208 adjacent to the coupling portions 1102 of the optical structures 110₁-110_{N} and aligned between each respective solder connects 1012 and via 1006. The solder balls 1011 may be sized such that when the solder balls 1011 is flattened due to the contact of the chip 108 being mounted on the PGL substrate 106, the solder balls 1011 is flattened to a height substantially the same as the height of the coupling portions 1102 of the optical structures 110₁-110_{N}. In the embodiment shown, the solder balls 1011 in contact with the vias 1006 and the interconnect pads 1004 electrically connect the chip 108 to the circuit traces 1002 in the package substrate 101. Further, one or more stand-off structures 1015 can be used to position, support and/or help align the chip 108 within the chip mounting region 204. In one example, the stand-off structures 1015 (FIG. 4) are formed to help set the vertical alignment of the waveguides 108A with the optical structures 110. In some embodiments, the PGL substrate 106 includes one or more stand-off structures 1015 that are configured to support the chip 108 in a direction (e.g., Z-direction) that is substantially perpendicular to a plane that is parallel to the plane in which the optical structures 110₁-110_{N} extend (e.g., X-Y-plane).

FIG. 6 is a schematic, cross-sectional lateral view of the fiber connector 112 portion of the photonic engine 105, according to some embodiments. In general, the fiber connector 112 is used to removably connect the external fiber cable 120 to the photonic engine 105. The optical fibers 112A of the fiber connector 112 transmit light signals to and from the fiber cable 120 plugged into the fiber connector 112. The fiber connector 112 is configured to allow for the attachment of external fiber cable 120 to the optical input/output of the photonic engine 105 without requiring active alignment of the fiber cable 120 to the photonic engine 105 on a per fiber core basis. As such, the fiber connector 120 may be formed and configured to be interoperable with a variety of different fiber cable 120 assemblies and standards. Light transmitted along the fibers 112A is directed to the optical structures 110₁-110_{N} on the PGL substrate 106 by a lens assembly for subsequent transmittance to and through the photonic engine 105. The lens assembly includes a first lens 112B and a third lens 112C formed on the fiber connector 112, and a second lens 1202 formed on the substrate 106. As shown, light from the fiber cable 120 is transmitted along the fiber 112A towards the first lens 112B formed near the end of the fiber 112A. The first lens 112B directs light transmitted along the fiber 112A towards the second lens 1202 on the PGL substrate 106. The second lens 1202 on the PGL substrate 106 then reflects and re-direct the light back towards the third lens 112C on the fiber connector 112. The third lens 112C finally reflects and re-directs the light to the optical structures 110 on the PGL substrate 106 for subsequent transmittance through the photonic engine 105.

FIGS. 1-6 have described optical photonic devices having multiple optical structures formed on a substrate (e.g., glass substrate). The optical photonic device can include a photonic chip mounted on the photonic substrate and connected to multiple optical structures. The optical structures optically connect the photonic chip to a fiber connector configured to connect with an external fiber and operate to propagate light signals between the fiber connector and the photonic chip.

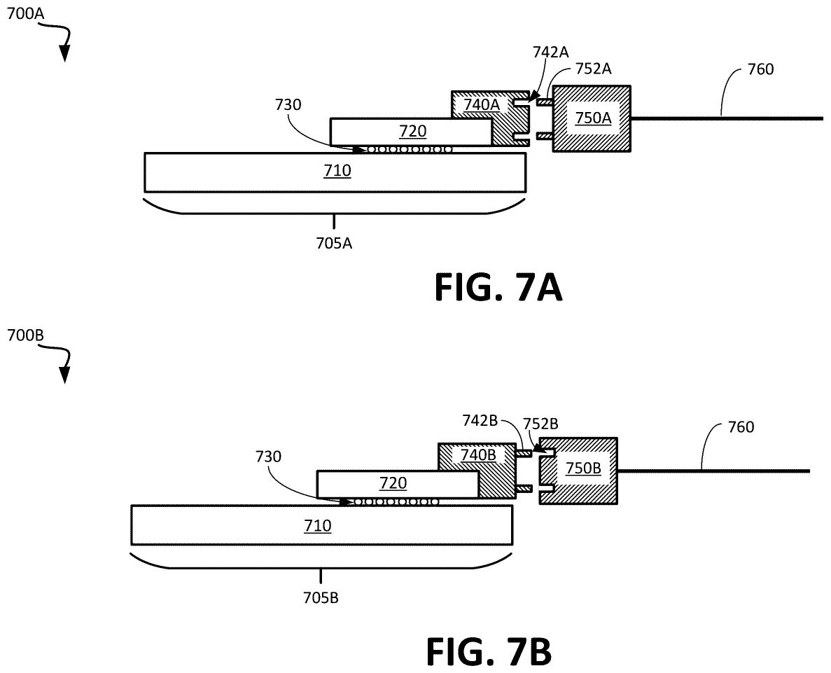

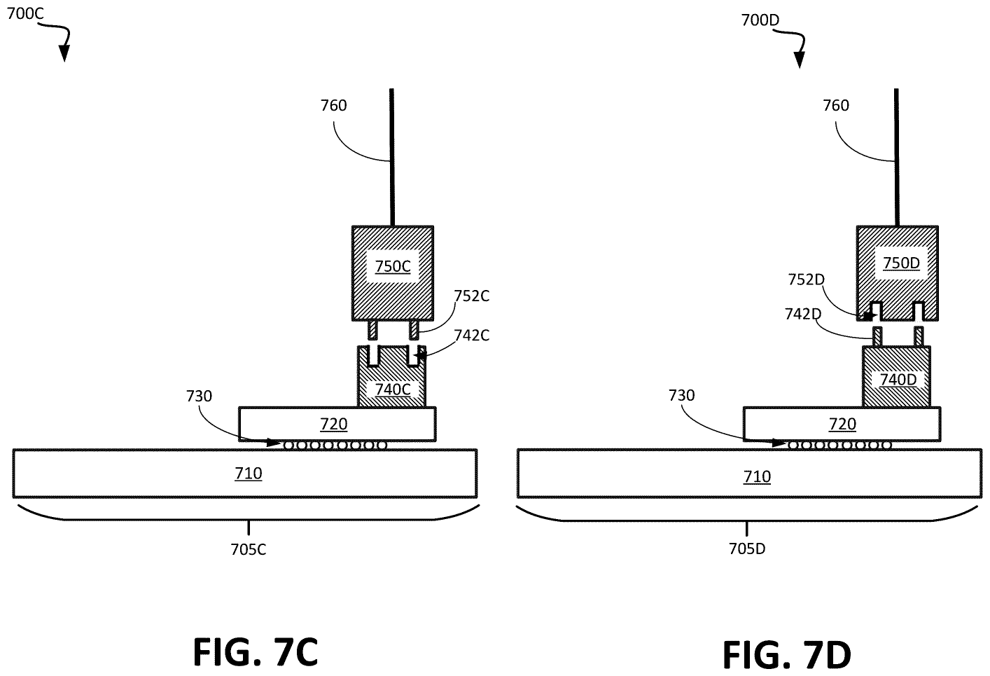

FIG. 7A is a diagram of system 700A, according to some embodiments. As shown in FIG. 7A, system 700A can include device 705A including substrate 710, at least one photonic integrated circuit (PIC) 720, ball grid array 730 formed between substrate 710 and PIC 720, and connection component 740A integrated within device 705A. More specifically, connection component 740A is formed on PIC 720. System 700A further includes connection component 750A coupled to optical fiber 760.

In this illustrative example, connection component 740A is a female connection component having a set of openings including opening 742A. Connection component 750A is a male connection component having a set of protrusions including protrusion 752A. Each opening of the set of openings of connection component 740A is designed to receive a respective protrusion of the set of protrusions of connection component 750A. For example, opening 742A is designed to receive protrusion 752A.

System 700A enables optical fiber-to-waveguide coupling on a plane parallel to an upper surface of substrate 710 (e.g., horizontal coupling). For example, connection component 740A is attached to PIC 720 in a manner enables the connection component 750A to be received along the plane parallel to the upper surface of substrate 710.

FIG. 7B is a diagram of a device or system 700B, according to some embodiments. As shown in FIG. 7B, system 700B can include device 705B including substrate 710, at least one PIC 720, ball grid array 730 formed between substrate 710 and PIC 720, and connection component 740B integrated within device 705B. More specifically, connection component 740B is formed on PIC 720. System 700B further includes connection component 750B coupled to optical fiber 760.

In this illustrative example, connection component 740B is a male connection component having a set of protrusions including protrusion 742B. Connection component 750B is a female connection component having a set of openings including opening 752B. Each opening of the set of openings of connection component 750B is designed to receive a respective protrusion of the set of protrusions of connection component 740B. For example, opening 752B is designed to receive protrusion 742B.

System 700B enables optical fiber-to-waveguide coupling on a plane parallel to an upper surface of substrate 710 (e.g., horizontal coupling). For example, connection component 740B is attached to PIC 720 in a manner enables the connection component 750B to be received along the plane parallel to the upper surface of substrate 710.

FIG. 7C is a diagram of a device or system 700C, according to some embodiments. As shown in FIG. 7C, system 700C can include device 705C including substrate 710, at least one PIC 720, ball grid array 730 formed between substrate 710 and PIC 720, and connection component 740C integrated within device 705C. More specifically, connection component 740C is formed on PIC 720. System 700C further includes connection component 750C coupled to optical fiber 760.

In this illustrative example, connection component 740C is a female connection component having a set of openings including opening 742C. Connection component 750C is a male connection component having a set of protrusions including protrusion 752C. Each opening of the set of openings of connection component 740C is designed to receive a respective protrusion of the set of protrusions of connection component 750C. For example, opening 742C is designed to receive protrusion 752C.

System 700C enables optical fiber-to-waveguide coupling on a plane perpendicular to an upper surface of substrate 710 (e.g., vertical coupling). For example, connection component 740C is attached to PIC 720 in a manner enables the connection component 750C to be received along the plane perpendicular to the upper surface of substrate 710.

FIG. 7D is a diagram of a device or system 700D, according to some embodiments. As shown in FIG. 7D, system 700D can include device 705D including substrate 710, at least one PIC 720, ball grid array 730 formed between substrate 710 and PIC 720, and connection component 740D integrated within device 705D. More specifically, connection component 740D is formed on PIC 720. System 700D further includes connection component 750D coupled to optical fiber 760.

In this illustrative example, connection component 740D is a male connection component having a set of protrusions including protrusion 742D. Connection component 750D is a female connection component having a set of openings including opening 752D. Each opening of the set of openings of connection component 750D is designed to receive a respective protrusion of the set of protrusions of connection component 740D. For example, opening 752D is designed to receive protrusion 742D.

System 700D enables optical fiber-to-waveguide coupling on a plane perpendicular to an upper surface of substrate 710 (e.g., horizontal coupling). For example, connection component 740D is attached to PIC 720 in a manner enables the connection component 750D to be received along the plane perpendicular to the upper surface of substrate 710.

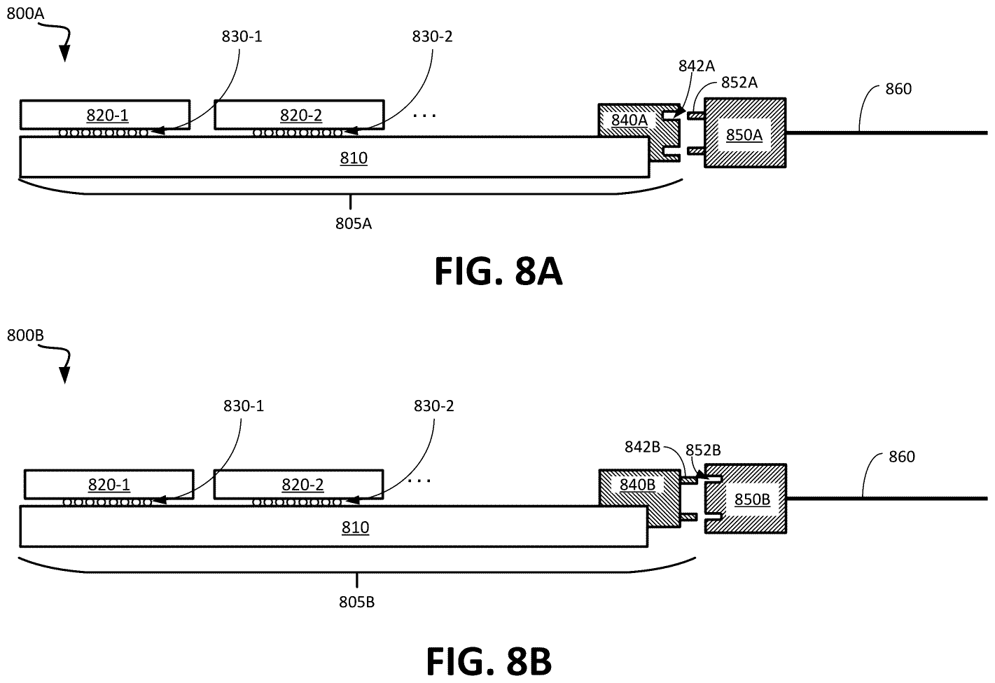

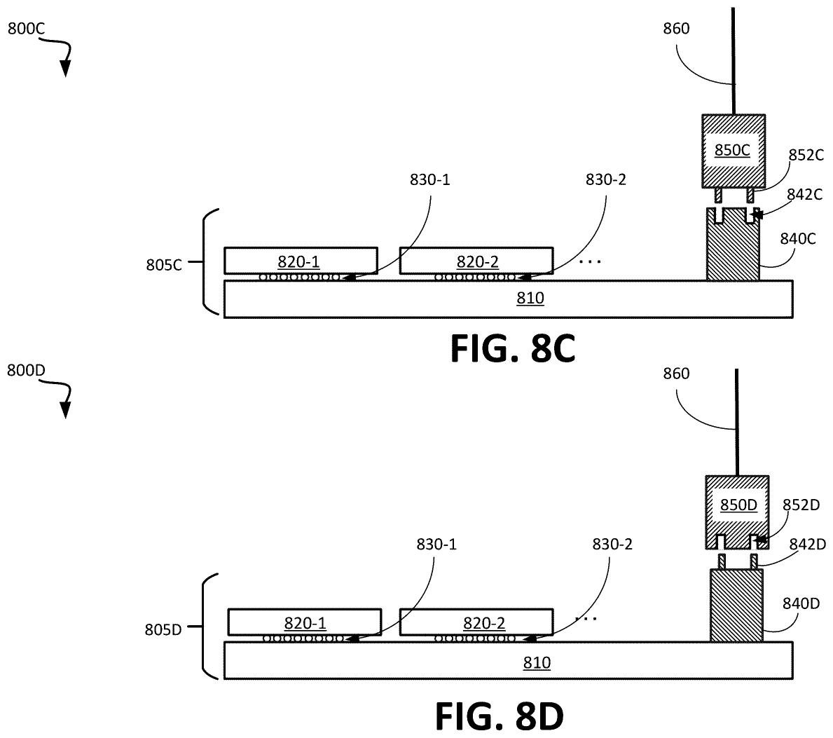

FIG. 8A is a diagram of a device or system 800A, according to some embodiments. As shown in FIG. 8A, system 800A can include device 805A including substrate 810, multiple PICs including PIC 820-1 and 820-1, multiple ball grid arrays formed between substrate 810 and respective ones of the PICs, including ball grid array 830-1 formed between substrate 810 and PIC 820-1 and ball grid array 830-2 formed between substrate 810 and PIC 820-2, and connection component 840A integrated within device 805A. More specifically, connection component 840A is formed on substrate 810. System 800A further includes connection component 850A coupled to optical fiber 860.

In this illustrative example, connection component 840A is a female connection component having a set of openings including opening 842A. Connection component 850A is a male connection component having a set of protrusions including protrusion 852A. Each opening of the set of openings of connection component 840A is designed to receive a respective protrusion of the set of protrusions of connection component 850A. For example, opening 842A is designed to receive protrusion 852A.

Similar to system 700A, system 800A enables optical fiber-to-waveguide coupling on a plane parallel to an upper surface of substrate 810 (e.g., horizontal coupling). For example, connection component 840A is attached to substrate 810 in a manner enables the connection component 850A to be received along the plane parallel to the upper surface of substrate 810.

FIG. 8B is a diagram of a device or system 800B, according to some embodiments. As shown in FIG. 8B, system 800B can include device 805B including substrate 810, PICs including PIC 820-1 and PIC 820-2, ball grid arrays including ball grid array 830-1 formed between substrate 810 and PIC 820-1 and ball grid array 830-2 formed between substrate 810 and PIC 820-2, and connection component 840B integrated within device 805B. More specifically, connection component 840B is formed on substrate 810. System 800B further includes connection component 850B coupled to optical fiber 860.

In this illustrative example, connection component 840B is a male connection component having a set of protrusions including protrusion 842B. Connection component 850B is a female connection component having a set of openings including opening 852B. Each opening of the set of openings of connection component 850B is designed to receive a respective protrusion of the set of protrusions of connection component 840B. For example, opening 852B is designed to receive protrusion 842B.

Similar to system 700B, system 800B enables optical fiber-to-waveguide coupling on a plane parallel to an upper surface of substrate 810 (e.g., horizontal coupling). For example, connection component 920 is attached to substrate 810 in a manner enables the connection component 850B to be received along the plane parallel to the upper surface of substrate 810.

FIG. 8C is a diagram of a device or system 800C, according to some embodiments. As shown in FIG. 8C, system 800C can include device 805C including substrate 810, PICs including PIC 820-1 and PIC 820-2, ball grid arrays including ball grid array 830-1 formed between substrate 810 and PIC 820-1 and ball grid array 830-2 formed between substrate 810 and PIC 820-2, and connection component 840C integrated within device 805C. More specifically, connection component 840C is formed on substrate 810. System 800C further includes connection component 850C coupled to optical fiber 860.

In this illustrative example, connection component 840C is a female connection component having a set of openings including opening 842C. Connection component 850C is a male connection component having a set of protrusions including protrusion 852C. Each opening of the set of openings of connection component 840C is designed to receive a respective protrusion of the set of protrusions of connection component 850C. For example, opening 842C is designed to receive protrusion 852C.

Similar to system 700C, system 800C enables optical fiber-to-waveguide coupling on a plane perpendicular to an upper surface of substrate 810 (e.g., vertical coupling). For example, connection component 840C is attached to substrate 810 in a manner enables the connection component 850C to be received along the plane perpendicular to the upper surface of substrate 810.

FIG. 8D is a diagram of a device or system 800D, according to some embodiments. As shown in FIG. 8D, system 800D can include device 805D including substrate 810, PICs including PIC 820-1 and PIC 820-2, ball grid arrays including ball grid array 830-1 formed between substrate 810 and PIC 820-1 and ball grid array 830-2 formed between substrate 810 and PIC 820-2, and connection component 840D integrated within device 805D. More specifically, connection component 840D is formed on substrate 810. System 800D further includes connection component 850D coupled to optical fiber 860.

In this illustrative example, connection component 840D is a male connection component having a set of protrusions including protrusion 842D. Connection component 850D is a female connection component having a set of openings including opening 852D. Each opening of the set of openings of connection component 850D is designed to receive a respective protrusion of the set of protrusions of connection component 840D. For example, opening 852D is designed to receive protrusion 842D.

System 800D enables optical fiber-to-waveguide coupling on a plane perpendicular to an upper surface of substrate 810 (e.g., horizontal coupling). For example, connection component 840D is attached to substrate 810 in a manner enables the connection component 850D to be received along the plane perpendicular to the upper surface of substrate 810.

FIG. 9 is a diagram of a device or system 900, according to some embodiments. As shown in FIG. 9, system 900 can include substrate 905 and connection component 910 formed on substrate 905. Connection component 910 can include first portion of a cladding layer (“cladding layer portion”) 912, first portion of a collimator assembly (“collimator assembly portion”) 914 formed in first portion of the cladding layer 912, and waveguide 916 formed in cladding layer portion 912. System 900 can further include connection component 920 corresponding to a detachable optical fiber component. Connection component 920 can include second portion of a cladding layer (“cladding layer portion”) 922, and second portion of the collimator assembly (“collimator assembly portion”) 924 formed in cladding layer portion 912. Connection component 920 can further include angle-cleaved optical fiber 926. The collimator assembly can increase the alignment tolerance of connection component 920. In some embodiments, collimator assembly portions 914 and 924 correspond to a pair of lenses forming a 4f optical system. In some embodiments, the collimator assembly is a meta-lens assembly. In some embodiments, the collimator assembly is a microlens assembly. In some embodiments, each lens has a diameter that ranges between about 30 μm to about 100 μm.

Optical signals 928 can travel through angle-cleaved optical fiber 926, which can, upon incidence at the interface between angle-cleaved optical fiber 926 and the surrounding environment (e.g., air), be directed toward the collimator assembly. In some embodiments, distance “A” ranges between about 300 μm to about 500 μm. In some embodiments, distance “A” is about 400 μm. Optical signals can pass through the collimator assembly and can be coupled to waveguide 916. Optical signals can be coupled to waveguide 916 with a small angle (e.g., less than or equal to about 20 degrees) to have a low impact on coupling loss. This can eliminate the need for a grating coupler or mirror alignment and can have relatively low loss and large 1 dB bandwidth in wavelength.

FIG. 10 is a diagram of a device or system 1000, according to some embodiments. As shown in FIG. 10, system 1000 can include substrate 1005 and connection component 1010 formed on substrate 1005. Connection component 1010 can include cladding layer 1012 formed on substrate 1005, trench 1013 formed at least through cladding layer 1012, mirror 1014 formed (e.g., coated) on a sidewall of trench 1013, and waveguide 222 formed within cladding layer 1012.

Trench 1013 can have a triangular cross-sectional shape (e.g., right triangular cross-sectional shape), and mirror 1014 can be formed on an angled sidewall of trench 1013 (e.g., the sidewall corresponding to the hypotenuse of the right triangular cross-sectional shape). In some embodiments, trench 1013 is formed by using a dry etch process. Connection component 1010 can further include a stack including substrate 1016 and portion of a second cladding layer (“cladding layer portion”) 1017 formed on substrate 1016. Cladding layer 1012 and substrate 1016 can be bonded together by bonding layer 1019. Portion of a collimator assembly (“collimator assembly portion”) can be formed between substrate 1016 and cladding layer portion 1017.

System 1000 can further include connection component 1020 corresponding to a detachable optical fiber connector including cleaved optical fiber 1022 formed on portion of the second cladding layer (“cladding layer portion”) 1024, and portion of the collimator assembly (“collimator assembly portion”) 1026 formed within cladding layer portion 1024. The collimator assembly can increase the alignment tolerance of connection component 1020. In some embodiments, collimator assembly portions 1019 and 1026 correspond to a pair of lenses forming a 4f optical system. In some embodiments, the collimator assembly is a meta-lens assembly. In some embodiments, the collimator assembly is a microlens assembly. In some embodiments, each lens has a diameter that ranges between about 30 μm to about 100 μm.

Optical signals 1028 can travel through cleaved optical fiber 1022, which can, upon incidence at the interface between cleaved optical fiber 1022 and cladding layer 1024, be directed toward the collimator assembly. The collimator assembly can then direct optical signals 1028 toward mirror 1014. Mirror 1014 can be designed to direct optical signals 1028 toward waveguide 222. Optical signals 1028 can be coupled into waveguide 222 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, distance “B” ranges between about 10 μm to about 20 μm. In some embodiments, distance “B” is about 15 μm. In some embodiments, distance “C” ranges between about 600 μm to about 800 μm. In some embodiments, distance “C” is about 700 μm. In some embodiments, distance “D” ranges between about 600 μm to about 800 μm. In some embodiments, distance “D” is about 700 μm.

In some embodiments, the optical fiber 1022 is separated from the cladding layer portion 1024 by a gap. In some embodiments, the optical fiber 1022 is separated from the cladding layer portion 1024 by one or more layers.

FIG. 11 is a diagram of a device or system 1100, according to some embodiments. As shown in FIG. 11, system 1100 can include substrate 1105 and connection component 1110 formed on substrate 1105. Connection component 1110 can include cladding layer 1111, a set of waveguides include waveguides 1112-1 through 1112-3 formed within cladding layer 1111, and mirror 1113 formed within cladding layer 1111 and on substrate 1105. More specifically, mirror 1113 can be formed within a trench formed within cladding layer 1111. In some embodiments, mirror 1113 is an angled mirror having a triangular cross-sectional shape (e.g., right-triangular cross-sectional shape). Connection component 1110 can further include layer 1114 formed on cladding layer 1112, and a first portion of a collimator assembly (“collimator assembly portion”) 1115 formed in layer 1114.

System 1100 can further include connection component 1120 corresponding to a detachable optical fiber component. Connection component 1120 can include cladding layer 1122, second portion of the collimator assembly (“collimator assembly portion”) 1124 formed in cladding layer 1122, and optical fiber 1126 formed in cladding layer 1122. Connection component 1120 can be attached to connection component 1110 via connectors 1130. More specifically, connectors 1130 can enable connection component 1120 to be detached from connection component 1110.

The collimator assembly can increase the alignment tolerance of connection component 920. In some embodiments, collimator assembly portions 1115 and 1124 correspond to a pair of lenses forming a 4f optical system. In some embodiments, the collimator assembly is a meta-lens assembly. In some embodiments, the collimator assembly is a microlens assembly. In some embodiments, each lens has a diameter that ranges between about 30 μm to about 100 μm.

Optical signals 1132 can travel through the set of waveguides, which can, upon incidence upon mirror 1113, be directed toward the collimator assembly. Optical signals 1132 can pass through the collimator assembly and can be coupled to optical fiber 1126. Optical signals 1132 can be coupled to optical fiber 1126 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, distance “E” corresponding to the distance between substrate 1105 and waveguide 1112-3 ranges between about 4 μm to about 8 μm. In some embodiments, distance “E” is about 5 μm. In some embodiments, distance “F” corresponding to the distance between layer 1114 and waveguide 1112-2 ranges between about 4 μm to about 8 μm. In some embodiments, distance “F” is about 5 μm. In some embodiments, width “G” corresponding to the width of layer 1114 ranges between about 100 μm to about 500 μm. In some embodiments, each lens has a diameter that ranges between about 30 μm to about 100 μm.

FIG. 12 is a diagram of a device or system 1200, according to some embodiments. As shown in FIG. 12, system 1200 can include substrate 1205 and connection component 1210 formed on substrate 1205. Connection component 1110 can include cladding layer 1212, waveguide 1214 formed within cladding layer 1212, and mirror 1216 formed within cladding layer 1212. More specifically, mirror 1216 can be formed within a trench formed within cladding layer 1212. In some embodiments, mirror 1216 is a concave mirror. In some embodiments, connection component 1210 further includes spacer 1218 formed on cladding layer 1212.

System 1200 can further include connection component 1220 corresponding to a detachable optical fiber component. Connection component 1220 can include cladding layer 1222, mirror 1224 formed in cladding layer 1222, and optical fiber 1226 formed in cladding layer 1222. More specifically, mirror 1224 can be formed within a trench formed within cladding layer 1222. In some embodiments, mirror 1224 is a concave mirror. Connection component 1220 can be attached to connection component 1210 via connectors 1230. More specifically, connectors 1230 can enable connection component 1220 to be detached from connection component 1210. In some embodiments, connectors 1230 are attached to spacer 1218. In some embodiments, connectors 1230 are attached to cladding layer 1212.

Optical signals 1232 can travel through waveguide 1214, which can, upon incidence upon mirror 1216, be directed toward mirror 1224. Upon incidence upon mirror 1224, optical signals 1232 can be coupled to optical fiber 1226. Optical signals 1232 can be coupled to optical fiber 1226 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, width “H” corresponding to the width of collimator layer 1212 ranges between about 20 μm to about 40 μm. In some embodiments, width “H” is about 30 μm. In some embodiments, width “I” corresponding to the width of spacer 1218 ranges between about 200 μm to about 400 μm. In some embodiments, width “I” is about 300 μm.

FIG. 13A is a diagram of a device or system 1300A, according to some embodiments. As shown in FIG. 13A, system 1300A can include substrate 1305 and connection component 1310A formed on substrate 1305. Connection component 1310A can include cladding layer 1312A formed on substrate 1305, trench 1313A formed at least through cladding layer 1312, mirror 1314A formed (e.g., coated) on a sidewall of trench 1313A, and waveguide 1315A formed within cladding layer 1312A. Trench 1313A can have a triangular cross-sectional shape (e.g., right triangular cross-sectional shape), and mirror 1314A can be formed on an angled sidewall of trench 1313A (e.g., the sidewall corresponding to the hypotenuse of the right triangular cross-sectional shape). In some embodiments, trench 1313A is formed by using a dry etch process. Connection component 1310A can further include microlens 1316A which forms a collimator assembly portion. In some embodiments, trench 1313A is filled with an index matched material (e.g., that matches to the index of cladding layer 1312). The Index matched material may be, for example SiOx, SiN, and/or another material.

System 1300A can further include connection component 1320 corresponding to a detachable optical fiber connector including cleaved optical fiber 1322 formed on microlens 1324. Microlens 1324 can form another collimator assembly portion. The collimator assembly can increase the alignment tolerance of connection component 1320. Accordingly, in these embodiments, the collimator assembly is a microlens assembly. In some embodiments, each lens has a diameter that ranges between about 30 μm to about 100 μm. Connection components 1310A and 1320 can be attached using mechanical connectors 1330A (e.g., pins or tubes).

Optical signals 1328 can travel through cleaved optical fiber 1322 toward the collimator assembly. The collimator assembly can then direct optical signals 1328 toward mirror 1314A. Mirror 1314A can be designed to direct optical signals 1328 toward waveguide 1315. Optical signals 1328 can be coupled into waveguide 1315 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, at least one of the microlens 1316A or 1324 is a freeform microlens. For example, at least one of the microlens 1316A or 1324 can be a cylindrical lens if the waveguide mode is elliptical. A freeform microlens can be designed with parametric surfaces, to convert arbitrary mode shape from waveguide to a symmetric circular shape to match the mode at the fiber end.

In some embodiments, distance “J” corresponding to the height of the trench 1313A ranges between about 5 μm to about 15 μm. In some embodiments, distance “J” is about 10 μm. In some embodiments, distance “K” corresponding to the distance between the apex of microlens 1316A and the surface of cladding layer 1312A ranges between about 200 μm to about 600 μm. In some embodiments, distance “K” is about 400 μm. In some embodiments, distance “L” corresponding to the distance between the apex of microlens 1324 and cleaved optical fiber 1322 ranges between about 200 μm to about 600 μm. In some embodiments, distance “L” is about 400 μm.

In some embodiments, the optical fiber 1322 is separated from the microlens 1324 by a gap. In some embodiments, the optical fiber 1322 is separated from the microlens 1324 by one or more layers.

FIG. 13B is a diagram of a device or system 1300B, according to some embodiments. As shown in FIG. 13B, system 1300B can include substrate 1305 and connection component 1310B formed on substrate 1305. Connection component 1310B can include cladding layer 1312B formed on substrate 1305, mirror 1314B formed within cladding layer 1312B, and waveguide 1315A formed within cladding layer 1312B. Connection component 1310B can further include metalens array or stack 1317B which forms a collimator assembly portion. In some embodiments, mirror 1314B is formed in a trench formed in cladding layer 1312B, and the trench is then backfilled with an index matched material that is index matched to the cladding layer 1312B after formation of the mirror 1314B.

System 1300B can further include connection component 1320 corresponding to a detachable optical fiber connector including cleaved optical fiber 1322 formed on microlens 1324, as described above with reference to FIG. 13A. Microlens 1324 can form another collimator assembly portion. The metalens array 1317B can be used to achieve lithography-defined overlay accuracy, broadband operation over the entire original band (O-band) (e.g., wavelengths ranging from about 1260 nanometers (nm) to about 1360 nm), and high flexibility of beam shaping. A metalens can be made of any suitable material. Examples of suitable materials include silicon (Si), titanium oxide (TiO₂), etc. The collimator assembly can increase the alignment tolerance of connection component 1320. Accordingly, in these embodiments, the collimator assembly is a hybrid microlens-metalens assembly. In some embodiments, each lens has a diameter that ranges between about 30 μm to about 100 μm. Connection components 1310B and 1320 can be attached using mechanical connectors 1330B (e.g., pins or tubes).

Optical signals 1328 can travel through cleaved optical fiber 1322 toward the collimator assembly. The collimator assembly can then direct optical signals 1328 toward mirror 1314A. Mirror 1314B can be designed to direct optical signals 1328 toward waveguide 1315. Optical signals 1328 can be coupled into waveguide 1315 with a small angle (e.g., less than or equal to about 20 degrees) to have a low impact on coupling loss. This can eliminate the need for a grating coupler or mirror alignment and can have relatively low loss and large 1 dB bandwidth in wavelength. In some embodiments, the microlens 1324 is a freeform microlens. For example, microlens 1324 can be a cylindrical lens if the waveguide mode is elliptical.

In some embodiments, distance “M” corresponding to the height of the mirror 1314B is less than or equal to about 10 μm. In some embodiments, the distance “M” is less than or equal to about 6 μm. The distance “L” is similar to the distance “L” described above with reference to FIG. 13A.

In some embodiments, the optical fiber 1322 is separated from the microlens 1324 by a gap. In some embodiments, the optical fiber 1322 is separated from the microlens 1324 by one or more layers.

FIG. 13C is a diagram of a device or system 1300C, according to some embodiments. As shown in FIG. 13B, system 1300C can include substrate 1305 and connection component 1310C formed on substrate 1305. Connection component 1310C can include cladding layer 1312C formed on substrate 1305, mirror 1314C formed within cladding layer 1312C, and waveguide 1315A formed within cladding layer 1312C. Connection component 1310C can further include microlens 1316C and metalens array or stack 1317C which forms a collimator assembly portion. The metalens array 1317C can be used to slow down the divergence of light.

System 1300C can further include connection component 1320 corresponding to a detachable optical fiber connector including cleaved optical fiber 1322 formed on microlens 1324, as described above with reference to FIGS. 13A-13B. Microlens 1324 can form another collimator assembly portion. The collimator assembly can increase the alignment tolerance of connection component 1320. Accordingly, in these embodiments, the collimator assembly is a hybrid microlens-metalens assembly. In some embodiments, each lens has a diameter that ranges between about 30 μm to about 100 μm. Connection components 1310C and 1320 can be attached using mechanical connectors 1330C (e.g., pins or tubes).

Optical signals 1328 can travel through cleaved optical fiber 1322 toward the collimator assembly. The collimator assembly can then direct optical signals 1328 toward mirror 1314A. Mirror 1314C can be designed to direct optical signals 1328 toward waveguide 1315. Optical signals 1328 can be coupled into waveguide 1315 with a small angle (e.g., less than or equal to about 20 degrees) to have a low impact on coupling loss. This can eliminate the need for a grating coupler or mirror alignment and can have relatively low loss and large 1 dB bandwidth in wavelength.

In some embodiments, at least one of the microlens 1316C or 1324 is a freeform microlens. For example, at least one of the microlens 1316C or 1324 can be a cylindrical lens if the waveguide mode is elliptical. The distances “M”, “K” and “L” are similar to the distances “K” and “L” described above with reference to FIGS. 13A-13B.

In some embodiments, the optical fiber 1322 is separated from the microlens 1324 by a gap. In some embodiments, the optical fiber 1322 is separated from the microlens 1324 by one or more layers.

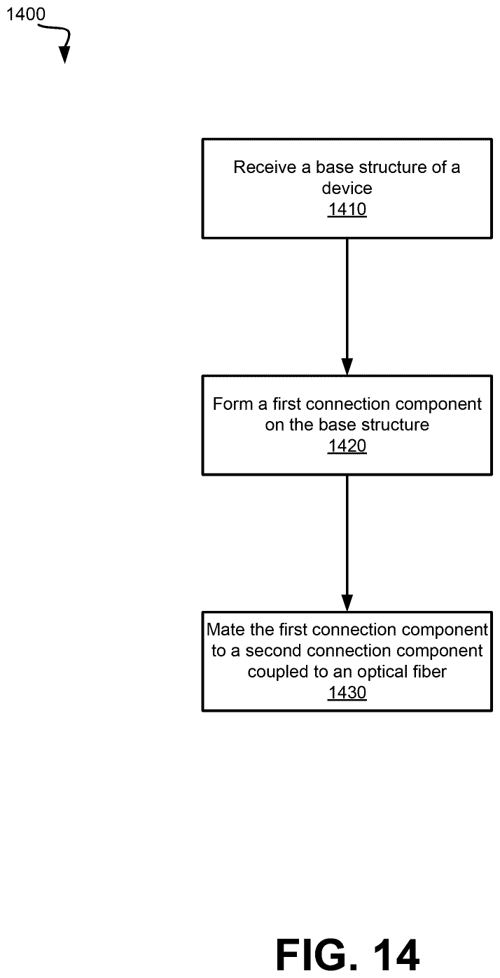

FIG. 14 is a flowchart of an example method to enable detachable optical fiber-to-waveguide coupling with standard optical fiber connector types, according to some embodiments.

At block 1410, a base structure of a device is received. Receiving the base structure can include forming at least one PIC on a substrate. For example, forming the at least one PIC on the substrate can include forming a ball grid array on the substrate, and forming the at least one PIC on the ball grid array.

At block 1420, a first connection component is formed on the base structure and, at block 1430, the first connection component is mated to a second connection component coupled to an optical fiber. In some embodiments, forming the first connection component on the base structure includes attaching the first connection component to the at least one PIC. In some embodiments, forming the first connection component on the base structure includes attaching the first connection component to the substrate. In some embodiments, the first connection component is a female component having a set of openings and the second connection component is a male component having a set of protrusions, where each protrusion is configured to mate with a respective opening of the set of openings. In some embodiments, the first connection component is a male component having a set of protrusions and the second connection component is a female component having a set of openings, where each protrusion of the set of protrusions is configured to mate with a respective opening of the set of openings.

In some embodiments, the first connection component corresponds to connection component 910 of FIG. 9 and the second connection component corresponds to connection component 920 of FIG. 9. In some embodiments, the first connection component corresponds to connection component 1010 of FIG. 10 and the second connection component corresponds to connection component 1020 of FIG. 10. In some embodiments, the first connection component corresponds to connection component 1110 of FIG. 11 and the second connection component corresponds to connection component 1120 of FIG. 11. In some embodiments, the first connection component corresponds to connection component 1210 of FIG. 12 and the second connection component corresponds to connection component 1220 of FIG. 12. In some embodiments, the first connection component corresponds to connection component 1310A of FIG. 13A and the second connection component corresponds to connection component 1320 of FIG. 13A. In some embodiments, the first connection component corresponds to connection component 1310B of FIG. 13B and the second connection component corresponds to connection component 1320 of FIG. 13B. In some embodiments, the first connection component corresponds to connection component 1310C of FIG. 13C and the second connection component corresponds to connection component 1320 of FIG. 13C. Further details regarding blocks 1410-1430 are described above with reference to FIGS. 1-13C.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system comprising:
a first connection component comprising a waveguide and a mirror formed on a base structure, the base structure comprising at least one photonic integrated circuit (PIC) formed on a substrate; and
a detachable second connection component coupled to an optical fiber, the detachable second connection component being configured to mate with the first connection component to enable optical signal coupling between the optical fiber and the waveguide;
wherein the mirror is configured to at least one of: reflect a first optical signal received from the waveguide to the optical fiber, or reflect a second optical signal received from the optical fiber to the waveguide.

2. The system of claim 1, wherein the first connection component is formed on the at least one PIC.

3. The system of claim 1, wherein the first connection component is formed on the substrate.

4. The system of claim 1, wherein the first connection component is a female connection component having a set of openings, wherein the detachable second connection component is a male connection component having a set of protrusions, and wherein each opening of the set of openings is designed to receive a respective protrusion of the set of protrusions.

5. The system of claim 1, wherein the first connection component is a male connection component having a set of protrusions, wherein the detachable second connection component is a female connection component having a set of openings, and wherein each opening of the set of openings is designed to receive a respective protrusion of the set of protrusions.

6. The system of claim 1, wherein at least one of the first connection component or the detachable second connection component comprises a microlens configured to expand and collimate at least one of: the first optical signal emitted from the waveguide into a first light beam having a diameter of approximately 30-150 micrometers, or the second optical signal emitted from the optical fiber into a second light beam having a diameter of approximately 30-150 micrometers.

7. The system of claim 6, wherein the first connection component and the detachable second connection component are configured to enable a 1-5 micrometer alignment accuracy between the first connection component and the detachable second connection component.

8. The system of claim 1, wherein at least one of the first connection component or the detachable second connection component comprises a metalens.

9. The system of claim 1, wherein the first connection component comprises a first microlens, and wherein the detachable second connection component comprises a second microlens and a metalens array.

10. The system of claim 1, wherein the optical fiber is approximately orthogonal to the waveguide.

11. A method comprising:
receiving a base structure comprising at least one photonic integrated circuit (PIC) formed on a substrate;
forming, on the base structure, a first connection component comprising a waveguide and a mirror; and
mating the first connection component to a detachable second connection component coupled to an optical fiber to enable optical signal coupling between the optical fiber and the waveguide;
wherein the mirror is configured to at least one of: reflect a first optical signal received from the waveguide to the optical fiber, or reflect a second optical signal received from the optical fiber to the waveguide.

12. The method of claim 11, wherein the first connection component is formed on the at least one PIC.

13. The method of claim 11, wherein the first connection component is formed on the substrate.

14. The method of claim 11, wherein the first connection component is a female connection component having a set of openings, wherein the detachable second connection component is a male connection component having a set of protrusions, and wherein each opening of the set of openings is designed to receive a respective protrusion of the set of protrusions.

15. The method of claim 11, wherein the first connection component is a male connection component having a set of protrusions, wherein the detachable second connection component is a female connection component having a set of openings, and wherein each opening of the set of openings is designed to receive a respective protrusion of the set of protrusions.

16. The method of claim 11, wherein at least one of the first connection component or the detachable second connection component comprises a microlens configured to expand and collimate at least one of: the first optical signal emitted from the waveguide into a first light beam having a diameter of approximately 30-150 micrometers, or the second optical signal emitted from the optical fiber into a second light beam having a diameter of approximately 30-150 micrometers.

17. The method of claim 11, wherein the first connection component and the detachable second connection component are mated with an alignment accuracy of 1-5 micrometers.

18. The method of claim 11, wherein at least one of the first connection component or the detachable second connection component comprises a metalens.

19. The method of claim 11, wherein the first connection component comprises a first microlens, and wherein the detachable second connection component comprises a second microlens and a metalens array.

20. The method of claim 11, wherein the first connection component comprises a mirror to reflect an optical signal received from the waveguide or the optical fiber to the optical fiber or the waveguide, respectively.
